(19) United States
(12) Patent Application Publication
(10) Pub. No.: US 2003/0034956 A1
(43) Pub. Date: Feb. 20, 2003

(54) Virtual e-marker

(76) Inventor: Yuichiro Deguchi, San Mateo, CA (US)

Correspondence Address: Seong-Kun Oh, Sierra Patent Group, P.O. Box 6149, Stateline, NV, 89449, US

(21) Appl. No.: 09/932,662

(22) Filed: Aug. 17, 2001

(51) Int. Cl. G09G 5/08

(52) U.S. Cl. 345/157

(57) ABSTRACT

Method and system for providing virtual emarker system includes a virtual emarker resident in a user terminal and configured to perform bookmarking operations to bookmark music clips broadcast over a registered radio or television station, and to communicate with a server terminal to retrieve information corresponding to bookmarked music clips such as the name of the music clip, the artist, and album information, and album purchase information.

### FIELD OF THE INVENTION

The present invention relates to electronic music marker devices. More particularly, the present invention relates to electronic music marker functions integrated into a user computer terminal.

### BACKGROUND OF THE INVENTION

Sony Corporation and its U.S. subsidiary, Sony Electronics, Inc., introduced an electronic music marker device which is capable of “bookmarking” a music clip while being played on a radio and, which, when synchronized with a gateway device such as a personal computer, is capable of recalling information related to the bookmarked music clip such as the name of the song, the artist, the album containing the song and so on. Using the, a user can conveniently recall the music clip information that the user listened to on the radio at a later time without the need to memorize the information or wait hopefully for the disc jockey on the radio to provide that information. In this manner, if the user wants to, for example, purchase the music album which the user has marked using the, the user can easily identify the necessary information related to the marked music clip from the e-marks provided by the.

While the has been introduced as a portable electronic device, to benefit from the capabilities of the electronic music marker device, a user must have easy and ready access to the electronic music marker device at all times especially when the user is in a surrounding where the user is listening to music broadcast over a radio station or a television station. In particular, to bookmark a music clip being broadcast over a registered radio or a television station, the user must stop whatever activity the user is engaged in at that particular time and retrieve the electronic music marker device from the user's pocket, key chain, handbag and the like to operate the electronic music marker device input button to book mark the music clip before the end of the broadcast.

It is often the case that at homes, schools, workplaces and the so-called cyber cafes that offer internet access terminals, a significant amount of time is spent before a computer terminal with internet access. Moreover, during a large portion of the time that the user spends in front of the computer terminal, it is common to find a radio being played or a television set tuned into a particular channel.

In view of the foregoing, it would be desirable to have an electronic music marker function integrated into computer terminals with internet access such that users may conveniently bookmark music clip broadcasts over a registered radio or television station via a mouse click on the computer terminal.

### SUMMARY OF THE INVENTION

A virtual data marking device in accordance with one embodiment of the present invention includes an input unit display configured to receive an input command to input a data mark, and a display unit configured to display the input data mark in response to the input command.

A method in accordance with another embodiment of the present invention includes displaying a data marking device including an input unit, receiving an input indication corresponding to an operation of the input unit, displaying a data mark corresponding to the operation.

A user terminal for displaying a virtual data marking device in accordance with a further embodiment of the present invention includes a controller, a display coupled to the controller, where the display is configured to display a virtual data marking device, an input unit coupled to the controller configured to control an input operation of the virtual data marking device, a memory coupled to the controller for storing data corresponding to the virtual data marking device, and a clock coupled to the controller, where the clock is configured to generate a time stamp in response to the input operation.

A virtual electronic music marker system of still a further embodiment of the present invention includes a connection, a server terminal coupled to the connection, and a user terminal coupled to the connection for communication with the server terminal, the user terminal including a display unit for displaying a three-dimensional representation of a data marking device, the user terminal further including an input unit for performing input operations of the data marking device to input one or more data marks, where the user terminal is configured to transmit the one or more data marks to the server terminal, and the server terminal is configured to retrieve information corresponding to the retrieved data marks and to transmit the retrieved information to the user terminal via the connection.

In the manner described above, in accordance with the various embodiments of the present invention, electronic music marker functionality is integrated into user terminals such as a personal computer such that the users may conveniently bookmark music clip broadcasts over a registered radio or television station via a mouse click on the computer terminal.

These and other features and advantages of the present invention will be understood upon consideration of the following detailed description of the invention and the accompanying drawings.

### BRIEF DESCRIPTION OF THE DRAWINGS

FIG. 1 illustrates one embodiment of a virtual emarker system;

FIG. 2 illustrates one embodiment of a user terminal in the virtual emarker system;

FIGS. 3A-3C illustrate one embodiment of virtual emarker installation and set up display on the user terminal in the virtual emarker system;

FIG. 4 illustrates one embodiment of a virtual emarker displayed on the user terminal in the virtual emarker system;

FIGS. 5A-5B illustrate one embodiment of virtual emarker bookmarking operation and uploading operation; and

FIG. 6 illustrates a flowchart of a virtual emarker installation and operation of one embodiment in the virtual emarker system.

### DETAILED DESCRIPTION

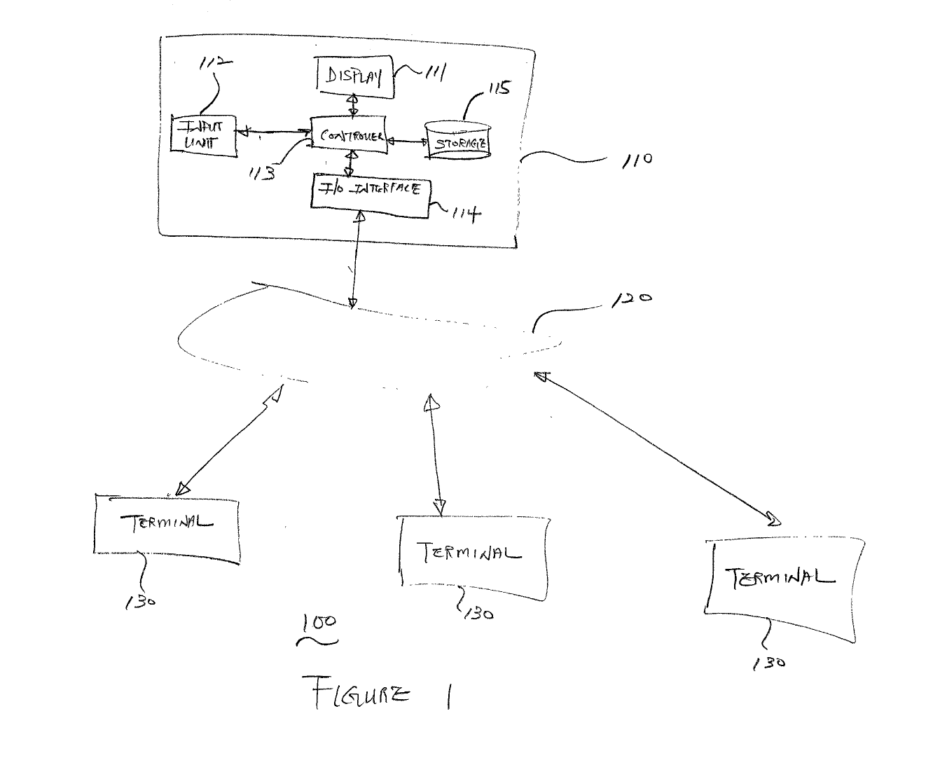

FIG. 1 illustrates one embodiment of a virtual emarker system. Referring to FIG. 1, virtual emarker system 100 includes server terminal 110 communicating a plurality of user terminals 130 via an internet connection over the world wide web 120. As shown, server terminal 110 includes display unit 111, input unit 112, controller 113, input/output (I/O) interface unit 114, and storage unit 115. Display unit 111 may be configured to display various information including the status of server terminal 110 connection, data transfer processing status, data upload information, and any other information related to the operation of server terminal 110.

Input unit 112 of server terminal 112 may be configured to provide input means for operations such as server terminal maintenance, data backup, data query and so on. As can be seen, both display unit 111 and input unit 112 are coupled to controller 113. In one embodiment, controller 113 may be configured to control the display of information on display unit 111 in accordance with input operations received from input unit 112. Alternatively, server terminal 110 may exclude display unit 111.

Referring back to FIG. 1, controller 113 of server terminal 110 is further coupled to storage unit 115 and I/O interface unit 114. In one embodiment, controller 113 may be configured to control data access, retrieval and updating of the stored data in storage unit 115. Moreover, controller 113 may further be configured to control the operation of I/O interface unit 114 which communicates with other terminals connected in the network over the internet connection 120. In one embodiment, I/O interface circuit 114 may include a communication port configured to connect to other terminals in the network via connections such as, but not limited to, a modem dial-up through an internet service provider (ISP), a DSL or cable modem-type connection, and a T1, ISDN or LAN type connection. Communication port integrated in I/O interface circuit 114 may include, among others, one of a USB port, a serial port, a parallel port, an IEEE 1394 communication port, a IrDA communication port, and a Bluetooth enabled communication port.

Referring again to FIG. 1, storage unit 115 of server terminal 110 may include internal or external storage devices such as a hard disc drive (HDD), a CD-RW drive, or a zip drive. In one embodiment, storage unit 115 may be configured to storage a variety of data received by server terminal 110 and processed by server terminal 110. Such data may include information related to registered user of the virtual emarker system (for example, including user name, address, account name, account password, and account status), as well as data related to the virtual emarker such as the software and the driver for installing the software at user terminals 130.

In one embodiment, the virtual emarker software and the driver may be embodied as a computer program developed using an object oriented language that allows the modeling of complex systems with modular objects to create abstractions that are representative of real world, physical objects and their interrelationships. However, it would be understood by one of ordinary skill in the art that the various embodiments as described herein may be implemented in many different ways using a wide range of programming techniques as well as general purpose hardware systems or dedicated controllers.

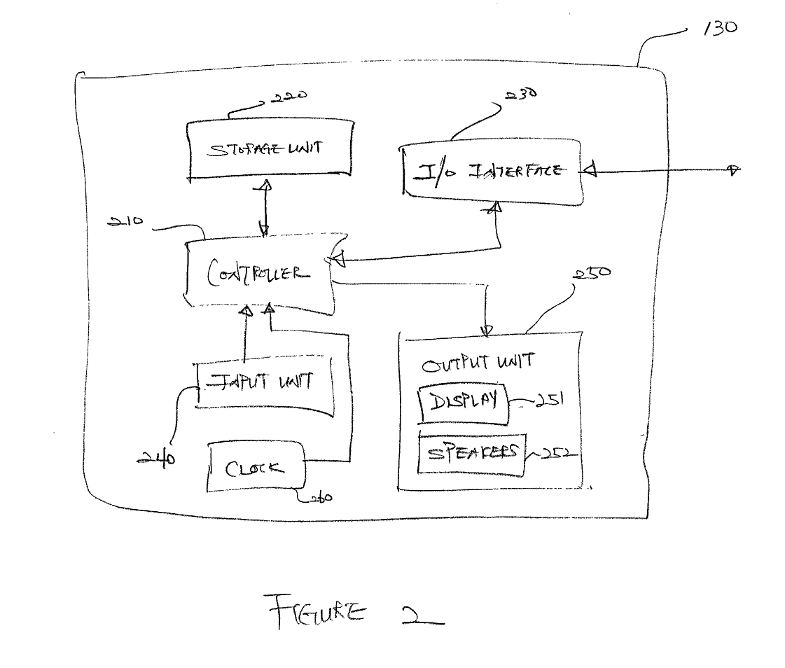

FIG. 2 illustrates one embodiment of a user terminal in the virtual emarker system. Referring to FIG. 2, user terminal 130 in one embodiment may include controller 210, storage unit 220, I/O interface unit 230, input unit 240, output unit 250 and clock 260. Similar to storage unit 115 of server terminal 130, storage unit 220 of user terminal 130 may include one or more of an internal or an external storage device such as a hard disc drive (HDD), a CD-RW drive, or a zip drive. Input unit 240 of user terminal 130 may include one of or a combination of a keyboard, a mouse, a touchpad input device and a voice-recognition type input terminal including a microphone with corresponding software installed in user terminal 130 for performing input operations by voice commands. Controller 210 is coupled to input unit 240 and accordingly, may be configured to process the input data received from input unit 240. Storage unit 220 is similarly coupled to controller 220, and may be configured to store inputted data received from input unit 240 or other data received by user terminal 130. Clock 260 also coupled to controller 210 may be configured to provide time information to controller 210 which, in turn, may be stored in storage unit 220 as discussed in further detail below.

Referring back to FIG. 2, I/O interface unit 230 in one embodiment may be coupled to controller 210, and may be configured to interface with other user terminals 130 in the network or to communicate with server terminal 110. In one embodiment, I/O interface circuit 230 of user terminal 130 may include a communication port configured to connect to the internet 120 via connections such as, but not limited to, a modem dial-up through an internet service provider (ISP), a DSL or cable modem-type connection, and a T1, IDSN or LAN type connection. Communication port integrated in I/O interface circuit 230 may include, among others, one of a USB port, a serial port, a parallel port, an IEEE 1394 communication port, a IrDA communication port, and a Bluetooth enabled communication port.

Referring again to FIG. 2, output unit 250 of user terminal 130 may include display unit 251 and speakers 251. Display unit 251 may be configured to output text, image (for example, in .jpg or .gif formats) or video data (for example, in .avi or .mpeg formats) while speakers may be configured to output sound data in the form of, for example, .wav file format. In this manner, user terminal 130 in one embodiment may be configured to communicate with server terminal 110 over the internet connection 120 in the virtual emarker system 100.

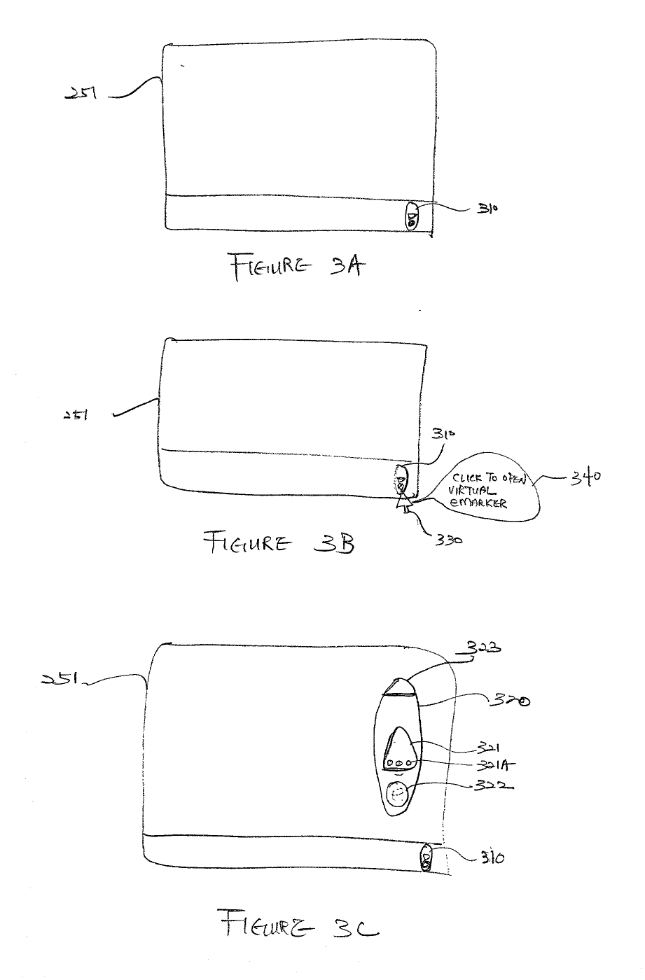

FIGS. 3A-3C illustrate one embodiment of virtual emarker installation and set up display on the user terminal in the virtual emarker system. Referring to FIGS. 3A-3C, display unit 251 of user terminal 130 is shown. When a user accesses his or her emarker account using user terminal 130, the user may be provided with an option to download a software to operate the virtual emarker. When the user decides to down the virtual emarker software by, for example, clicking on a corresponding icon displayed on display unit 251 of user terminal 130, server terminal 110 in response to the user input, transmits the virtual emarker software to user terminal 130 via internet connection 120. After the download operation at user terminal 130, the user may be prompted to decide whether to install the downloaded virtual emarker software, or alternatively, the virtual emarker software may automatically initiate the installation procedure at user terminal 130.

Once the virtual emarker software is downloaded onto user terminal 130, as shown in FIG. 3A, emarker icon 310 may be configured to appear on display unit 251 of output unit 250 of user terminal 130. In one aspect, by moving arrow cursor 330 using a mouse (as input unit 240, for example) over emarker icon 310, help balloon 340 may appear by arrow cursor 330. As shown in FIG. 3B, help balloon 340 may display “Click to Open Virtual eMarker” prompting the user to operate the mouse to click arrow cursor 330 over emarker icon 310.

Upon operating the mouse to click arrow cursor 330 over emarker icon 310, virtual emarker 320 is displayed on display unit 251 of user terminal 130. In particular, as shown in FIG. 3C, virtual emarker 320 displayed on display unit 251 of user terminal 130 may include virtual emarker display unit 321 configured to display emarks 321A, virtual emarker input unit 322, and virtual emarker cap portion 323. In one embodiment, as discussed in further detail below, by moving arrow cursor 330 over the various portions of virtual emarker 320, the user may operate virtual emarker 320 to bookmark music clips broadcast over registered radio or television stations.

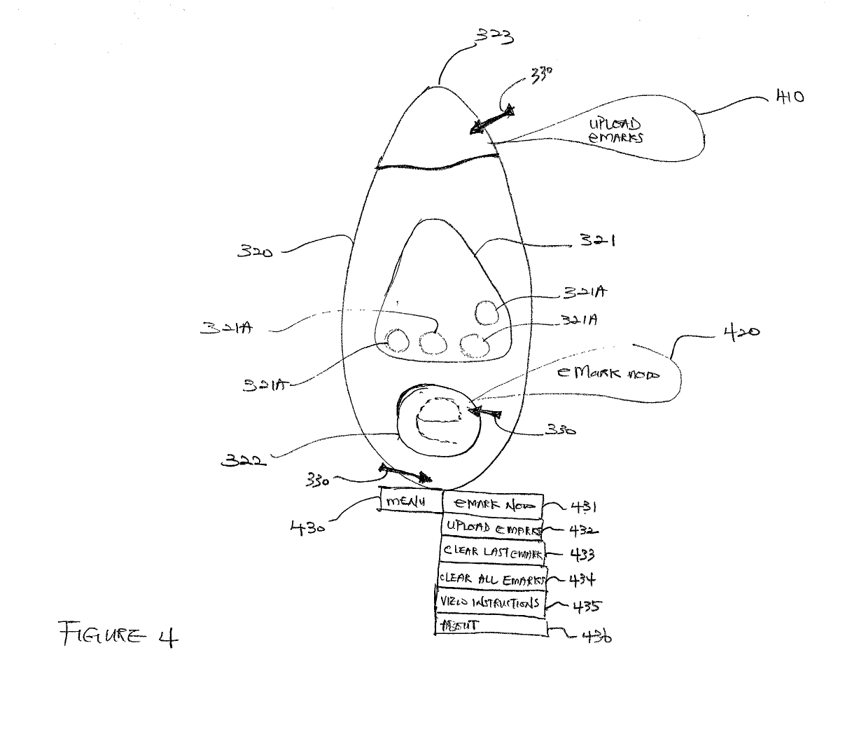

FIG. 4 illustrates one embodiment of a virtual emarker displayed on the user terminal in the virtual emarker system. Referring to FIG. 4, virtual emarker operation may be achieved by moving arrow cursor 330 over various portions of virtual emarker 320. In particular, when arrow cursor 330 is moved over virtual emarker cap portion 323 by using, for example, a mouse as input unit 240, help balloon 410 appears substantially in close proximity to cursor arrow 330 and displays “Upload eMarks”, indicating that virtual emarker cap portion 323 is configured to upload emarks by clicking one of the input buttons on the computer mouse. Similarly, when cursor arrow 330 is moved over virtual emarker input unit 322, help balloon 420 appears substantially in close proximity to cursor arrow 330 displaying “eMark now” indicating that when the user operates one of the input buttons on the computer mouse (which is configured to move the cursor arrow 330) over virtual emarker input unit 322, the user may bookmark a music clip being broadcast over a registered radio or television station, and a corresponding emark 321A may be configured to appear on virtual emarker display unit 321 indicating to the user that the bookmarking operation was successful.

When cursor arrow 330 is moved over the bottom end portion of virtual emarker 320, scroll down menu 430 may be displayed as shown in FIG. 4. In particular, scroll down menu 430 may be configured to display in a cascaded manner various input sections for performing the corresponding functions of an electronic music marker device. For example, emark now input section 431 may be selected by cursor arrow to bookmark a music clip, upload emarks input section 432 may be selected to upload stored emarks to server terminal 110, clear last emark input section 433 may be selected to clear the last emark input by the user, clear all emark input section 434 may be selected to clear all stored emarks in virtual emarker 320, and view instructions input section 435 may be selected to view instructions on the operation and function of virtual emarker 320 which may be a separate pop-up window displayed on display unit 251 of user terminal 130.

In the manner described above, using input unit 240 such as a computer mouse or a stylus type pen on a touch-sensitive pad screen, the user may operate virtual emarker 320 to bookmark music clips broadcast over registered radio or television station conveniently from user terminal 130. Furthermore, since virtual emarker 320 takes up relatively small amount of display area of display unit 251, the user may leave the virtual emarker 320 loaded and displayed in user terminal 130 while performing other tasks for quick and easy access to virtual emarker 320.

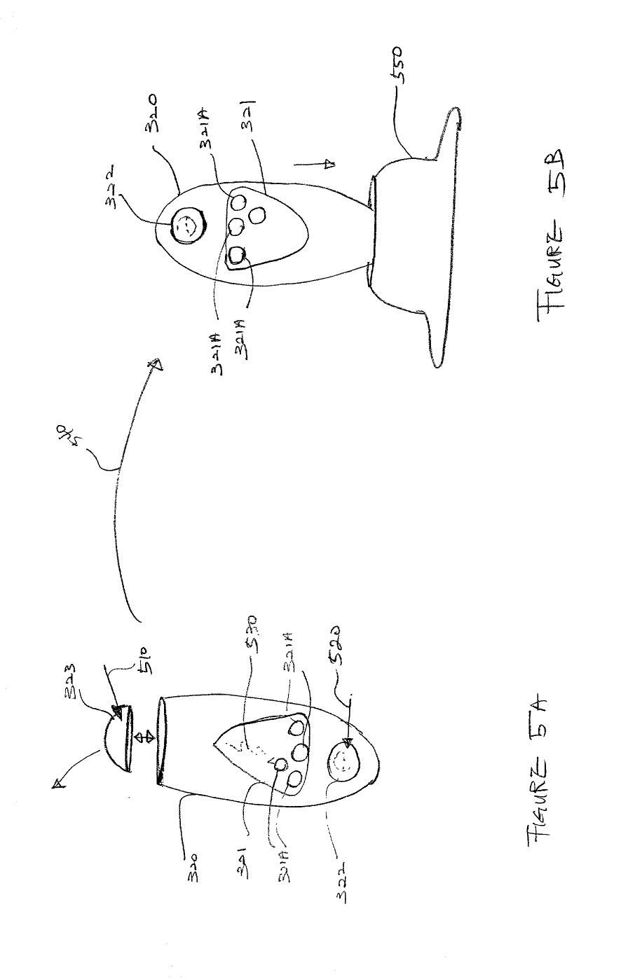

FIGS. 5A-5B illustrate one embodiment of virtual emarker bookmarking operation and uploading operation. Referring to FIGS. 5A-5B, when the user operates virtual emarker input unit 322 by moving arrow cursor 520 over virtual emarker input unit 322 and clicking on the input button of the mouse (which, in this case is configured to control the movement of arrow cursor 520), corresponding emark 321A shown in FIG. 5A is animated and displayed in a descending manner along the path shown by dotted arrow 530. Moreover, referring back to FIG. 2, clock 260 of user terminal 130 may be configured to provide time information to controller 210 when virtual emarker input unit 322 is operated, and storage unit 220 may be configured to store the time information corresponding to each input operation of virtual emarker input unit 322. With each subsequent operation of virtual emarker input unit 322, corresponding emarks 321A may be configured to be displayed in a similar manner in virtual emarker display unit 321.

For emark uploading operation, when the user moves arrow cursor 510 over virtual emarker cap portion 323 and operates the input button on the computer mouse controlling the movement of arrow cursor 510, in one embodiment, virtual emarker cap portion 323 may be configured to separate from the main body of virtual emarker 320 such that display unit 251 of user terminal 130 displays virtual emarker cap portion 32 being uncapped from the main body of virtual emarker 320. Thereafter, uncapped virtual emarker 320 is placed in virtual cradle 550 by an animated display sequence following the path of arrow 540.

Once docked in virtual cradle 550, emarks 321A displayed in virtual emarker display unit 321 may be configured to descend, either sequentially one by one, or all together, from its position on virtual emarker display unit 321 towards virtual cradle 550 and emark uploading operation is initiated. In an alternate embodiment, each animated sequence of virtual emarker cap portion 323 detaching from the main body of virtual emarker 320 to the falling of emarks 321A once virtual emarker 320 is docked in virtual cradle 550 may be accompanied by a corresponding sound such as a beep or a melodic tune output through speakers 252 of output unit 250 of user terminal 130. In this manner, in accordance with one embodiment of the present invention, virtual emarker 320 may be configured to provide the functionality of the portable electronic music marker device for bookmarking music clips broadcast over a registered radio or television station.

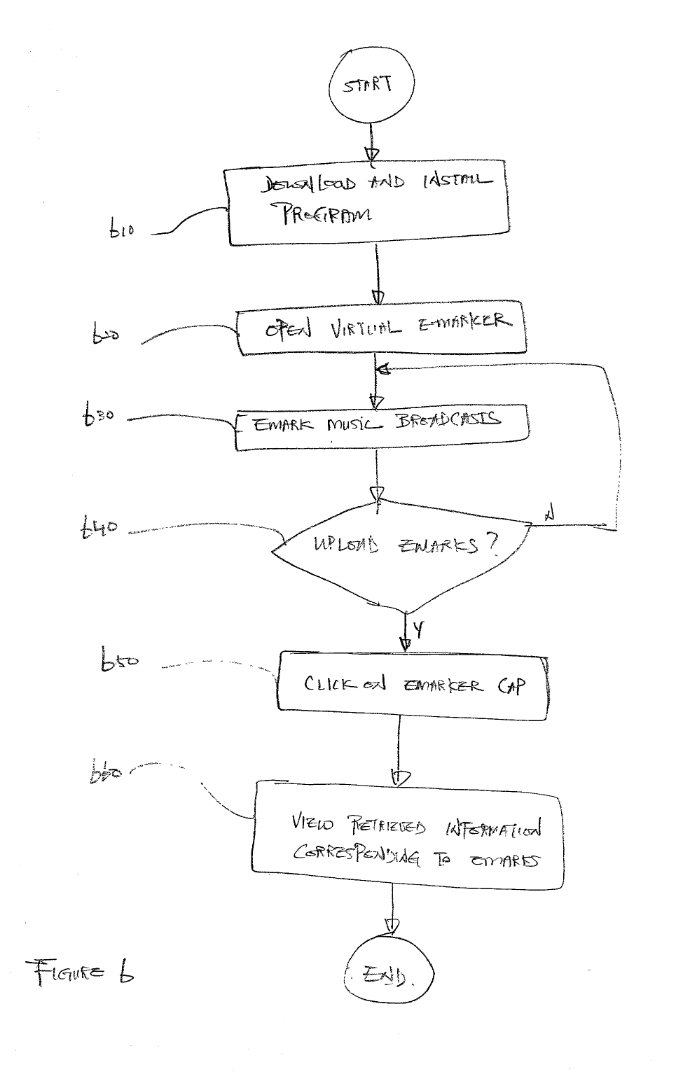

FIG. 6 illustrates a flowchart of a virtual emarker installation and operation of one embodiment in the virtual emarker system. Referring to FIG. 6, when the user initiates a virtual emarker installation procedure from user terminal 130, at step 610, virtual emarker program is downloaded from server terminal 110 to user terminal 130 via internet connection 120 and installed in user terminal 130. Upon installation, at step 620, virtual emarker 320 is displayed on display unit 251 of user terminal 130. At step 630, the user may operate virtual emarker 320 as discussed above to bookmark music clips broadcast over a registered radio or television station, and may continue to bookmark broadcast music clips until at step 640 the user decides to upload the emarks 321A.

At step 650, the user clicks on virtual emarker cap portion 323 which initiates the emark uploading procedure as discussed above in conjunction with FIGS. 5A-5B. In particular, upon initialing the emark uploading procedure, user terminal 130 transmits stored emarks and corresponding time information to server terminal 110 via internet connection. Server terminal 110 in turn retrieves the corresponding information for each received emark and transmits the retrieved information to user terminal 130 for output display to the user at step 660.

In one embodiment, the information received from server terminal 110 corresponding to each emark may include the name of the artist of the emarked music clip, the name of the album for the emarked music clip, the name of the emarked music clip, a short sample sound clip of the emarked music clip, an image of the emarked music clip album, an image of the emarked music clip artist, as well as information related to purchasing the album containing the emarked music clip such as a hypertext link displayed on display unit 251 of user terminal 130 to the web sites of online music vendors such as amazon.com and CDNow.com, and their respective sale prices of the desired music album.

In the manner described above, virtual emarker 320 in accordance with various embodiments of the present invention may be conveniently provided to consumers for use through user terminals 130. While a personal computer type device has been used to describe user terminal 130, within the scope of the present invention, user terminal 130 may include handheld devices such as internet enabled personal digital assistants (PDAs), WAP-enabled mobile telephones, i-mode mobile telephones, portable computing devices such as laptop computers with wireless internet connection. Moreover, while virtual emarker system above is described with one user terminal 130 communicating with server terminal 110, within the scope of the present invention, multiple user terminals 130 may be configured to communicate with server terminal 110 simultaneously or near simultaneously via internet connection 120. Moreover, user terminals 130 may further be configured to communicate with each other over internet connection 120 such that each user terminal 130 may transmit and receive information to and from other user terminals 130 in virtual emarker system network.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A virtual data marking device, comprising:
an input unit display configured to receive an input command to input a data mark; and
a display unit configured to display said input data mark in response to said input command.

2. The device of claim 1 wherein said input unit display includes a graphic representation corresponding to an input unit of a data marking device.

3. The device of claim 2 wherein said data marking device includes an electronic music marker device.

4. The device of claim 2 wherein said graphic representation is substantially circular in shape.

5. The device of claim 1 wherein said data mark includes a time stamp.

6. The device of claim 1 wherein said display unit includes a graphical representation corresponding to a display unit of a data marking device.

7. The device of claim 6 wherein said data marking device includes an electronic music marker device.

8. The device of claim 1 wherein said input unit display and said display unit substantially form a three-dimensional graphical representation of an electronic music marker device.

9. A method, comprising:
displaying a data marking device including an input unit;
receiving an input indication corresponding to an operation of said input unit; and
displaying a data mark corresponding to said operation.

10. The method of claim 9 wherein said displaying step includes the step of three-dimensionally displaying said data marking device.

11. The method of claim 9 wherein said input unit displayed includes a graphical representation of an input button of a data marking device.

12. The method of claim 11 wherein said input button graphical representation is substantially circular in shape.

13. The method of claim 9 wherein said receiving said input indication step includes the step of operating an input device.

14. The method of claim 13 wherein said input device includes one of a computer mouse, a keyboard, and a touch-sensitive pad.

15. The method of claim 9 wherein said data mark is displayed within said displayed data marking device.

16. The method of claim 9 further including the step of retrieving a time stamp information corresponding to said input indication.

17. The method of claim 16 further including the step of storing said time stamp information.

18. The method of claim 9 further including the step of coupling said displayed data marking device with a cradle display.

19. The method of claim 18 wherein said cradle display includes a three-dimensional graphical representation of a cradle configured to couple to said data marking device.

20. The method of claim 18 further including the step of animating said data mark within said displayed data marking device after said coupling step.

21. A user terminal for displaying a virtual data marking device, comprising:
a controller;
a display coupled to said controller, configured to display a virtual data marking device;
an input unit coupled to said controller configured to control an input operation of said virtual data marking device;
a memory coupled to said controller for storing data corresponding to said virtual data marking device; and
a clock coupled to said controller, configured to generate a time stamp in response to said input operation.

22. The terminal of claim 21 wherein said display includes one of a cathode ray tube, a liquid crystal display, a plasma display panel, a touch-sensitive type display, and a projection type display.

23. The terminal of claim 21 wherein said input unit includes one of a computer mouse, a keyboard, a stylus for use with a touch-sensitive type display, and a microphone.

24. The terminal of claim 21 wherein said memory includes one or more of a random access memory, a hard disc drive, a CR-RW drive, a zip drive, and a web-based storage unit.

25. The terminal of claim 12 wherein said controller is configured to generate a control signal for controlling the operation of said display, said input unit, said memory and said clock.

26. The terminal of claim 21 wherein said controller is configured to retrieve stored data from said memory, and to store data in said memory.

27. The terminal of claim 21 further including a communication port configured to connect to one or more external devices.

28. The terminal of claim 27 wherein said communication port includes one or more of a USB port, a parallel port, a serial port, an ethernet port, an IrDA port, and a Bluetooth enabled port.

29. The terminal of claim 27 wherein said controller is configured to transmit and/or receive data to and/or from said one or more external devices via said communication port.

30. A virtual electronic music marker system, comprising;
a connection;
a server terminal coupled to said connection; and
a user terminal coupled to said connection for communication with said server terminal, said user terminal including a display unit for displaying a three-dimensional representation of a data marking device, said user terminal further including an input unit for performing input operations of said data marking device to input one or more data marks;
wherein said user terminal is configured to transmit said one or more data marks to said server terminal; and further
wherein said server terminal is configured to retrieve information corresponding to said retrieved data marks and to transmit said retrieved information to said user terminal via said connection.

31. The system of claim 30 wherein said connection includes an internet connection.

32. The system of claim 30 wherein said server terminal includes a storage unit for storing said information corresponding to said data marks and said received data marks.

33. The system of claim 30 wherein said user terminal further includes a speaker for outputting audible data.

34. The system of claim 30 wherein said user terminal input unit includes one of a computer mouse, a keyboard, a stylus for use with a touch-sensitive type display, and a microphone.

35. The system of claim 30 wherein said user terminal further includes a clock for generating a time stamp in response to said input operation.

36. The system of claim 36 wherein said user terminal further includes a memory for storing said time stamp and said data marks.

37. The system of claim 36 wherein said user terminal memory includes one or more of a random access memory, a hard disc drive, a CR-RW drive, a zip drive, and a web-based storage unit.

38. The system of claim 30 wherein each of said user terminal and said server terminal includes a respective communication port.

39. The system of claim 38 wherein said user terminal communication port and said server terminal communication port each includes one or more of a USB port, a parallel port, a serial port, an ethernet port, an IrDA port, and a Bluetooth enabled port.
